(19) United States
(12) Patent Application Publication
(10) Pub. No.: US 2010/0322546 A1
(43) Pub. Date: Dec. 23, 2010

(54) Freehub ball bearing carrier

(76) Inventor: Jeroen Bosboom, Orange, CA (US)

Correspondence Address: Jeroen Bosboom, 321 S. Earlham Street, Orange, CA, 92869, US

(21) Appl. No.: 12/819,189

(22) Filed: Sep. 2, 2010

Related U.S. Application Data
(60) Provisional application No. 61/219,360, filed on Jun. 22, 2009.

(51) Int. Cl. F16C 35/12

(52) U.S. Cl. 384/545

(57) ABSTRACT

The invention pertains to a component attached to the rear hub of a bicycle, namely the freehub. The design of the current bicycle freehub contains a plastic bushing used to support the freehub and rider pedaling loads. The freehub ball bearing carrier is designed to fit seamlessly into the rear hub, providing a unique way of converting the standard freehub plastic bushing to a sealed ball bearing, thus improving the wear characteristics of the freehub.

### CROSS-REFERENCE TO RELATED APPLICATIONS

This application claims the benefits of U.S. Provisional Patent Application No. 61219360, Entitled “BALL BEARING CARRIER ASSEMBLY FOR MAVIC® 2001 TO 2009 AND ON, SPECIFIC TO FTS-L AND FTS-X FREEHUBS,” filed on 22 Jun. 2009. This application hereby incorporates by reference the above-identified provisional application in its entirety.

| | | |
|---|---|---|
| 4,567,973 | February 1986 | Butz |
| 4,580,670 | April 1986 | Nagano |
| 5,194,051 | March 1993 | Nagano |
| 5,460,254 | October 1995 | Huang |
| 5,738,197 | April 1998 | Kroger et al. |
| 5,882,088 | March 1999 | Yahata |
| 5,954,604 | September 1999 | Nakamura |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention generally relates to the mechanism of a bicycle freehub, specifically the rear hub. It is particularly directed for use with the Mavic® line of rear bicycle hubs using the “FTS-L” and “FTS-X” designation. The “FTS-L” denotes the freehub cassette interface standard by Shimano® and the “FTS-X” denotes the freehub cassette interface standard by Campagnolo®. The two freehubs are interchangeable on any given Mavic® hub from this series, but require different cassettes due to their differing outer profile. Specifically, this invention improves the above mentioned Mavic® freehub in the following ways: considerably increases the longevity of the freehub; eliminates premature hub wear; eliminates vibration and noise; extends maintenance intervals; reduces uneven pawl loads and improves the overall performance of the freehub—all without machining the original freehub assembly.

Earlier versions of Mavic® freehubs, (prior to 2001), were designed using an inner and outer ball bearing, at each end of the freehub, to support the pedaling load. The Mavic® freehub design was later revised in 2001 and the inner ball bearing was discontinued and replaced with a plastic bushing. The hardened steel freehub shell is very tough and can be rebuilt almost indefinitely. In the standard Mavic® freehub assembly a lip seal was also placed next to the bushing to keep road grit and debris from entering the bushing journal. The Mavic® new re-designed freehub was reduced in size so only a very thin walled, (1 mm wall), plastic bushing would fit as opposed to the large ball bearing, (25×37×7 mm), previously fitted. The manufacturer's one bushing size freehub assembly (with inner bushing and outer bearing installed) often fits too loose for many hubs due to hub wear and production tolerances. The new plastic bushing can withstand the compressive load of the large ball bearing (25×37×7 mm), but it does not fare well in regards to withstanding abrasive wear. The hub journal is hard anodized aluminum which is also prone to wear. Normal use of the standard plastic bushing equipped freehub leads to extreme friction and noise from the freehub body at the end of its short life. Side effects of this are poor shifting, hub wear and the possibility of rider distraction. Regarding the plastic bushing, the manufacturer, Mavic,® does not offer the plastic bushing as a replacement part. A few enterprising individuals sell machined plastic bushings in the after market. However, these plastic bushings suffer from the same manufacture limitations as the stock plastic bushing, as described above. Also, if a given hub assembly is worn out, plastic bushing replacement can't restore the freehub operation to optimal performance. (Worn out is regarded as the hub journal surface anodizing having worn through to the base metal.) The hub assembly can not be purchased as an individual component, but only as a part of a wheel assembly.

### BRIEF SUMMARY OF THE INVENTION

The freehub ball bearing carrier replaces the plastic inner freehub bushing and fits entirely in the available space of the standard bushing and lip seal pocket. No machining or spoke removal is required to install it. The high performance inner and outer hybrid ceramic ball bearing and adapter provide an ideal replacement option for Mavic® rear hubs. The freehub ball bearing carrier is equipped with an annular lip seal for enclosed cavity style hubs and is removable for use in the open cavity hubs that use a separate compact freehub ball bearing carrier lip seal instead. By removing the standard (Mavic®) lip seal on the hub journal the small protrusion of the new freehub ball bearing carrier is accommodated in the existing hub assembly. This feature has the advantage of supporting the cassette load over two ball bearings that are spaced 4 mm wider apart than before. The wider bearing spacing improves the freehub stability compared to the standard plastic bushing and ball bearing design. When assembled the hub is indistinguishable from a standard hub in regards to overall length or physical appearance.

This invention solves the dilemma of purchasing an entire freehub assembly that is prone to wear and which only comes in one bushing size and over time wears out the non-replaceable hub. With each successive stock freehub assembly replacement the optimum clearance increases since the hub wear is not accounted for in the replacement freehub assembly. Therefore the freehub and hub lifespan is reduced due to the worn hub surface and increased bushing clearance at the start of its use, further reducing the service interval. These issues are solved by the freehub ball bearing carrier replacement kit.

There are minor differences in the bushing counter bore depths of the FTS-L” and “FTS-X freehubs. The freehub ball bearing carrier accommodates both types with one adaptor design. The original Mavic® freehub seal design proved useful to my invention since the space it added to the original assembly is useful for my invention.

By installing the freehub ball bearing carrier replacement kit the hub journal is no longer subject to wear from the inner bushing. All the sliding surfaces are contained with in the new inner ball bearing. The freehub ball bearing carrier replacement kit also makes it possible to repair a hub that has a worn out bearing journal. Journal surfaces which have worn through the anodizing fit too loosely around the freehub bushing and are a source for friction and noise as mentioned. Since the freehub ball bearing carrier inner ball bearing seats the inner ball bearing past the worn journal surface of the hub it has secure support with no unwanted lash. The kit components can be installed with simple hand tools and by following the detailed instructions in the kit. It can be installed by the handy bicycle enthusiast.

The freehub ball bearing carrier is a unique, original and non-obvious solution to this particular line of rear hubs. It is not an obvious solution since the manufacturer reduced the freehub shell mass and diameter to fit only a thin wall plastic bushing. It is also unique since we have revised a commercial series thin section ball bearing to include a full complement of Si3N4 silicone nitride balls so it can with stand the loads applied formerly to a much larger bearing. These two improvements taken together complement each other and make possible a very much appreciated freehub solution for the bicycle enthusiast. We are therefore very pleased to have successfully designed, tested and sold this product in the USA.

The Mavic® wheel owner now has a choice for resolving this service and design issue with the freehub ball bearing carrier assembly incorporated in The freehub ball bearing carrier freehub replacement assembly. I have sold over 500 hundred freehub ball bearing carrier freehub kits since filing a provisional patent almost a year ago. I have many repeat buyers from bicycle repair shops as well as enthusiasts and I'm often told that this invention saved someone from having to purchase a replacement wheel or wheel set. Others comment that the freehub ball bearing carrier is ingeniously designed and well executed and that they are more pleased than ever with their Mavic® wheel set. Typically these Mavic® wheel sets cost $500 to as much as $2500 for carbon fiber road wheels.

### BRIEF DESCRIPTION OF THE SEVERAL VIEWS OF THE DRAWING

In the following brief description and in several figures of the drawing, like elements are identified with like reference numbers.

Referring now to FIG. 1, shown therein is a perspective view of a Mavic® style rear hub assembly which includes the freehub in the Shimano® cassette interface fitted with the freehub ball bearing carrier. This style of hub is referred to here as “enclosed” since the hub pocket around the base of the freehub has walls that are not interrupted by slots for spoke anchors.

Referring now to FIG. 2, shown therein is a Mavic® style rear hub assembly as described in FIG. 1 with the view shown as a cross-section.

FIG. 2.1 Shows a close up of the freehub ball bearing carrier.

Referring now to FIG. 3, shown is the exploded Shimano style freehub with the freehub ball bearing carrier parts.

Referring now to FIG. 4, shown therein is a perspective view of a Mavic® rear hub assembly which includes the freehub in the Campagnolo® cassette interface fitted with the freehub ball bearing carrier. This style of hub is referred to here as ‘open” since the hub pocket around the base of the freehub has walls that are interrupted by slots for spoke anchors.

Referring to FIG. 5, shown therein is a Mavic® style rear hub assembly as described in FIG. 4 with the view shown as a cross section.

FIG. 5.1 Shows a close up of the freehub ball bearing carrier.

Referring now to FIG. 6, shown is the exploded Campagnolo® style freehub with the freehub ball bearing carrier parts.

### DETAILED DESCRIPTION OF INVENTION

In the following detailed description and in several figures of the drawing like elements are identified with like reference numerals.

Referring now to FIG. 1, the various components are identified for clarity and only the freehub ball bearing carrier is proposed as a new patentable invention.

Referring now to FIG. 1, Part numbers, 1 hub body, 2 freehub body FTS-L “Shimano®”, 3 drive side axle stub, 4 non-drive side axle screw.

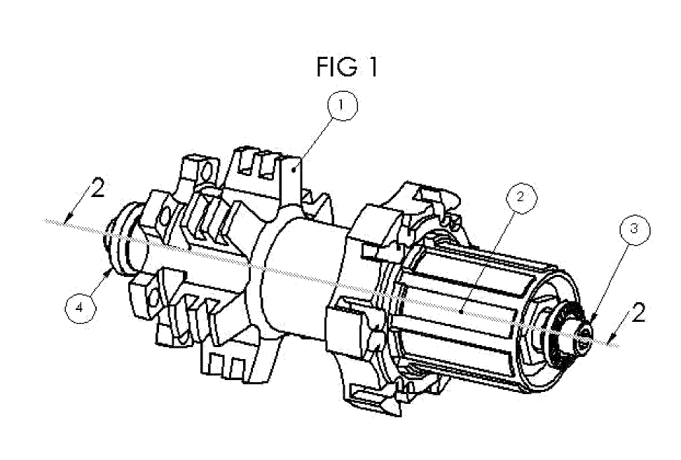

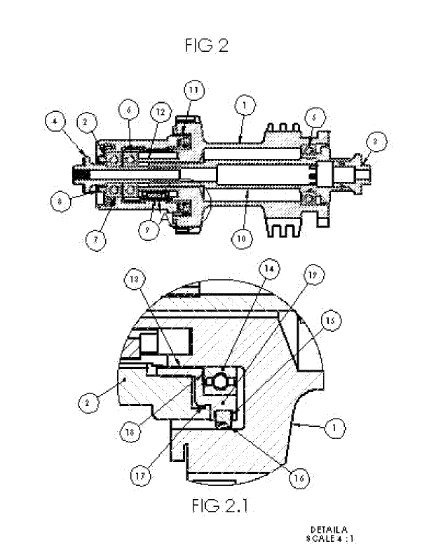

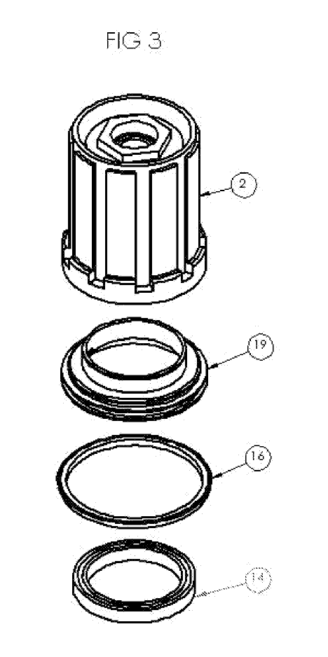

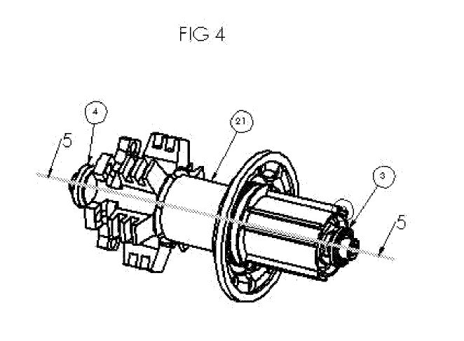

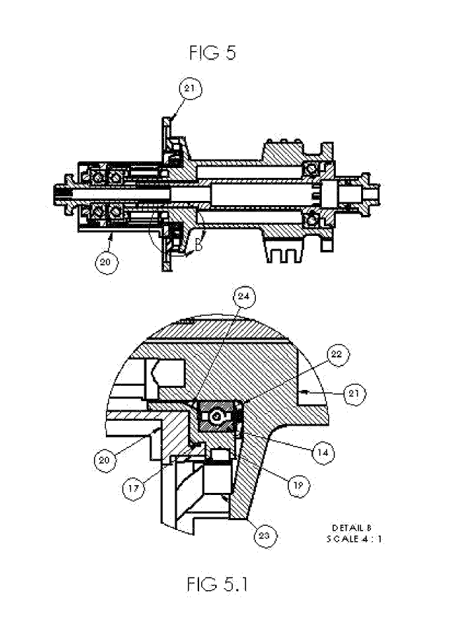

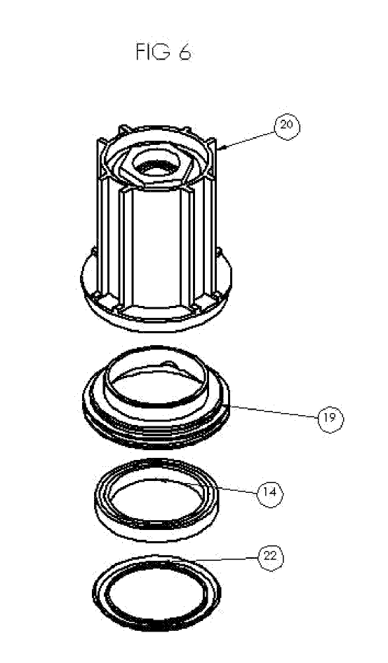

Referring now to FIG. 2, Part numbers 5 non-drive side axle bearing, 6 drive side axle bearing, 7 freehub outer bearing, 8 freehub outer bearing cap, 9 ratchet pawls, 10 inner axle, 11 enclosed hub pocket, 12 ratchet pawl pivot pin.

Referring now to FIG. 2.1, shown therein is a Mavic® FTS-L “Shimano®” style freehub assembly with freehub ball bearing carrier kit installed. Part numbers, 13 close fitting freehub ball bearing carrier provides a “limp home” feature by supporting the freehub between the journal surface even if the inner ball bearing fails, 14 6705-2RS hybrid ceramic ball bearing, 15 lip seal slot, 16 lip seal for enclosed hubs, 17 retaining notch in freehub ball bearing carrier prevents loosening of the assembly, 18 inner race relief avoids drag and contact, 19 freehub ball bearing carrier shell, 14 6705-2RS hybrid ceramic ball bearing.

Referring now to FIG. 3, part number 2 Mavic® FTS-L “Shimano®” style freehub, 19 freehub ball bearing carrier shell, 16 lip seal for enclosed hubs, 14 6705-2RS hybrid ceramic ball bearing, 56 ceramic Si3N4 balls with no cage and C3 loose clearance.

Referring now to FIG. 4, Part numbers, 21 hub body, 20 freehub body FTS-X Campagnolo®, 3 drive side axle stub, 4 non-drive side axle screw.

Referring now to FIG. 5, Part numbers 21 hub body, 20 freehub body FTS-X Campagnolo®

Referring now to FIG. 5.1, shown therein is a Mavic® FTS-X Campagnolo® style freehub assembly with freehub ball bearing carrier kit installed. Part numbers, 13 close fitting freehub ball bearing carrier provides “limp home” feature by supporting the freehub even if the inner ball bearing fails, 14 6705-2RS hybrid ceramic ball bearing, 22 lip seal for open hubs, 17 retaining notch in freehub ball bearing carrier prevents loosening of the assembly, 18 inner race relief avoids drag and contact, 19 freehub ball bearing carrier shell, 14 6705-2RS hybrid ceramic ball bearing, 23 hub slot for spoke attachment.

Referring now to FIG. 6, part number 2 Mavic® FTS-X Campagnolo®” style freehub, 19 freehub ball bearing carrier shell, 22 lip seal for open hubs, 14 6705-2RS hybrid ceramic ball bearing, 56 ceramic Si3N4 balls with no cage and C3 loose clearance.

By closely following the contours of the back of the Mavic® freehub the freehub ball bearing carrier “adapter” fits tightly into the back of the freehub in the same manner as the stock plastic bushing. However by adding an extension in the shape of a ball bearing counter bore pocket a unique and original solution was invented to fit a thin section ball bearing in place of the bushing. The freehub ball bearing carrier (13) inner diameter has minimal clearance over the hub journal in case the inner ball bearing ever fails the freehub and cassette will be stable enough to “limp home”. The adapter outer diameter is a press fit into the steel freehub body on two diameters. The outer sleeve helps align the two pieces while the outer diameter is substantially supported by the surrounding flange of the steel freehub body. It also has a built in retainer lip (17) which snaps into a mating groove on the freehub body. Taken together these press fit features anchor the adapter solidly in the freehub body with out the need for adhesives. The adapter also has two internal notches (24) which allow the ball bearing inner race to be accessed with a punch in case the ball bearing needs to be pressed out for service. The inner face of the adapter has a clearance step (18) so the inner race does not rub during operation. The outer surface of the adapter has an annular groove (15) which allows the installation of a lip seal which keeps the dirt and debris out of the inner hub cavity.

To install the freehub ball bearing carrier assembly the standard plastic bushing is be pried out and the freehub ball bearing carrier custom bearing adapter is pressed into the hub instead. A plastic shot filled mallet can be used to hammer the freehub down over the freehub ball bearing carrier until it seats. The special full ball complement 25×32×4 mm hybrid ceramic bearing has a light film of Loctite® 609 applied and pressed into the adapter in the same manner. A bearing press or flat jawed vise is also a recommended installation method. The bearings internal clearance of “C3” is slightly reduced but not eliminated as a result of the installation. Increasing or decreasing the internal bearing clearance is embodied in other variants. The freehub assembly is the fitted over the hub. An interference with the inner race and the journal is sometimes encountered. A light sanding tool of the journal diameter eliminates the interference. The 6705-2RS series bearing inner race diameter can be increased in other versions to avoid re-sizing the hub diameter.

The Inner ball bearing (14) is based on a 6705-2RS series bearing but with special provisions. The standard ball cage and its 21 steel balls is replaced with 56 silicone nitride (Si3N4) balls. This fills up the races and increases the load capacity markedly in a very compact bearing. A “load port” is incorporated into the ball bearing to allow balls to be added during assembly. This consists of a notch on the inside of the outer race that is close to the full depth of the ball groove. The bearing is purposely assembled to a “C3” loose clearance so that it can be press fit into the installed adapter and keep and adequate running clearance. Two standard rubber seals shield the bearing (14) from contamination. By substituting the standard steel balls with a full complement of ceramic balls the bearings the load supporting surface is increased. The increased load capacity and extremely durable ceramic balls enable a thin profile ball bearing to fit a tightly confined space where a relatively large and heavy bearing was needed before. The freehub ball bearing carrier weight is only 12.5 grams.

The Outer lip seal replaces the stock lip seal that was removed to make space for the freehub ball bearing carrier adapter. It is intended for enclosed style hubs that surround the freehub base. This ensures that the inner sealed ball bearing is also sealed form the elements.

The adapter seal is a stretch fit over the adapter body and slips into the provided groove. The adapter seal spins with the freehub body and is static relative to the hub when pedaling takes place. The adapter seal is designed so the base is thick enough to counteract compression loads while the thin lip portion is compressed into the hub cavity. The second Flat lip seal is for hubs that have an open style flange with protruding spokes close to the freehub body. The former adapter seal rubs the spoke ends and is removed from the adapter by simply peeling it out. The Flat lip seal fits (22) around the hub journal and between the freehub ball bearing carrier face and the bottom of the hub pocket. The flat lip seal is molded around an internal metal washer to prevent the base of the seal from distorting when the sealing lips are compressed. The inner lip contacts the inner races of the 6705 bearing helping to keep the seal stationary in the hub pocket. The outer lip of the flat seal contacts the adapter face and flexes to seal the assembly. The seal lip is intended to be lubricated with light oil. The Flat lip seal spins with the hub body and is static relative to the freehub when pedaling takes place.

1. A freehub ball bearing carrier comprised of an aluminum sleeve, rubber seal and ceramic ball bearing replaces a plastic bushing in a Mavic® bicycle freehub.

2. The freehub ball bearing carrier of claim 1 is designed to fit Mavic® FTS-L freehubs.

3. The freehub ball bearing carrier of claim 1 is designed to fit Mavic® FTS-X freehubs.
